(19) United States
(12) Patent Application Publication
(10) Pub. No.: US 2015/0262735 A1
(43) Pub. Date: Sep. 17, 2015

(54) METHOD OF MAKING COPPER-CLAD GRAPHENE CONDUCTING WIRE

(71) Applicant: MERRY ELECTRONICS (SUZHOU) CO., LTD., Suzhou City (CN)

(72) Inventor: Tse-Yu LIU, Taichung City (TW)

(73) Assignee: MERRY ELECTRONICS (SUZHOU) CO., LTD., Suzhou City (CN)

(21) Appl. No.: 14/206,517

(22) Filed: Mar. 12, 2014

(51) Int. Cl. H01B 13/004; H01B 13/30; H01B 13/00

(52) U.S. Cl. CPC H01B 13/004; H01B 13/0006; H01B 13/30; H01B 13/0016; H01B 13/0026

(57) ABSTRACT

A method of making a copper-clad graphene conducting wire is disclosed. By encapsulating graphene oxide inside a copper material, stretching the copper material to form a conducting wire and then reducing the graphene oxide at a high temperature provided by an annealing or baking step, the goal of making a copper-clad graphene conducting wire in a simple way is achieved.

### BACKGROUND OF THE INVENTION

1. Field of the Invention

The present invention relates generally to methods of making conducting wires and more particularly, to a method of making a copper-clad graphene conducting wire.

2. Description of the Related Art

A copper conducting wire clad with a single-layered or multi-layered graphene at an outer circumference thereof may encounter a welding difficulty as the graphene-clad copper conducting wire is welded with a regular copper conducting wire or with the copper pad of a printed circuit board assembly (PCBA). To solve this welding problem, it is needed to develop a graphene conducting wire having copper disposed at an outer layer thereof. However, it is difficult to encapsulate the graphene inside a copper material due to the properties of graphene.

### SUMMARY OF THE INVENTION

The present invention has been accomplished under the circumstances in view. It is an objective of the present invention to provide a method of making a copper-clad graphene conducting wire.

To attain the above-mentioned objective, the technical solution adopted by the present invention is to provide a method of making a copper-clad graphene conducting wire comprising the steps of:

a) encapsulating graphene oxide inside a copper material;

b) stretching the copper material step by step to form a conducting wire;

c) annealing the conducting wire at a temperature of 100° C. to 1000° C.;

d) applying paint on the conducting wire and then baking the conducting wire; and

f) cooling and then receiving the conducting wire.

Preferably, the step c) may be carried at a temperature of 550° C. to 750° C.

Preferably, the step c) may be carried out under the protection of nitrogen gas.

A method of making a copper-clad graphene conducting wire is further provided comprising the steps of:

a) encapsulating graphene oxide inside a copper material;

b) stretching the copper material step by step to form a conducting wire;

c) applying paint on the conducting wire and then baking the conducting wire at a temperature of 100° C. to 1000° C.; and

d) cooling and then receiving the conducting wire.

Preferably, the conducting wire is baked at a temperature of 300° C. to 500° C. in step c).

By means of the above-mentioned technical solution, the present invention has the following advantages compared to the prior art.

The present invention adopts the method of encapsulating graphene oxide inside a copper material, stretching the copper material to form a conducting wire and then heating the conducting wire. When the graphene oxide is heated, oxygen is ionized and the graphene oxide is reduced to graphene. Therefore, the objective of making a copper-clad graphene conducting wire in a simple way is achieved. Because the outer layer of the conducting wire provided by the present invention is still a copper layer, the copper-clad graphene conducting wire of the present invention is applicable in the application of current welding technique.

### DETAILED DESCRIPTION OF EMBODIMENTS

The present invention will become more fully understood from the detailed description of embodiments of the present invention given hereunder.

### Embodiment 1

A method of making a copper-clad graphene conducting wire comprises the following the steps.

a) Encapsulate graphene oxide inside a copper material.

b) Stretch the copper material step by step to form a conducting wire.

c) Annealing the conducting wire at a temperature of 650° C. under nitrogen gas protection.

d) Apply paint on the conducting wire and then bake the conducting wire repeatedly.

F) Cool and then receive the conducting wire.

In this embodiment, the graphene oxide encapsulated inside the copper material is reduced to graphene by the high temperature provided by the annealing step. When graphene oxide is heated at high temperature under the protection of inert gas, the graphene oxide is reduced to graphene, thereby achieving the objective of making a copper-clad graphene conducting wire in a simple way.

### Embodiment 2

A method of making a copper-clad graphene conducting wire comprises the following steps.

a) Encapsulate graphene oxide inside a copper material.

b) Stretch the copper material step by step to form a conducting wire.

c) Apply paint on the conducting wire and then bake the conducting wire at a temperature of 350° C.

d) Cool and receive the conducting wire.

In this embodiment, the graphene oxide encapsulated inside the copper material is reduced to graphene by the high temperature provided by the baking step. The step of reducing the graphene oxide to the graphene by the high temperature of baking may be carried out under the protection of inert gas so as to achieve the objective of making a copper-clad graphene conducting wire in a simple way.

It should be understood that the detailed description and specific example, while indicating preferred embodiment of the invention, are given by way of illustration only, and thus are not limitative of the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of making a copper-clad graphene conducting wire comprising the steps of:
a) encapsulating graphene oxide inside a copper material;
b) stretching the copper material step by step to form a conducting wire;
c) annealing the conducting wire at a temperature of 100° C. to 1000° C.;
d) applying paint on the conducting wire and then baking the conducting wire; and
f) cooling the conducting wire and then receiving the conducting wire.

2. The method as claimed in claim 1, wherein the step c) is carried at a temperature of 550° C. to 750° C.

3. The method as claimed in claim 1, wherein the step c) is carried out under protection of nitrogen gas.

4. A method of making a copper-clad graphene conducting wire comprising the steps of:
a) encapsulating graphene oxide inside a copper material;
b) stretching the copper material step by step to form a conducting wire;
c) applying paint on the conducting wire and then baking the conducting wire at a temperature of 100° C. to 1000° C.; and
d) cooling the conducting wire and then receiving the conducting wire.

5. The method as claimed in claim 4, wherein in the step c) the conducting wire is baked at a temperature of 300° C. to 500° C.
